(19) United States
(12) Patent Application Publication
(10) Pub. No.: US 2018/0122307 A1
(43) Pub. Date: May 3, 2018

(54) BACKLIGHT BRIGHTNESS AUTOMATIC ADJUSTING SYSTEM ADAPTING VARIOUS LIQUID CRYSTAL PANELS AND LIQUID CRYSTAL DISPLAY

(71) Applicant: Shenzhen China Star Optoelectronics Technology Co., Ltd., Shenzhen City (CN)

(72) Inventors: Wendong Li, Shenzhen City (CN); Li Zhou, Shenzhen City (CN)

(21) Appl. No.: 15/039,416

(22) PCT Filed: Apr. 13, 2016
(86) PCT No.: PCT/CN2016/079164

§ 371 Date: May 26, 2016

(30) Foreign Application Priority Data
Mar. 9, 2016 (CN) 201610134256.0

(51) Int. Cl. G09G 3/34; G02F 1/1335; G09G 3/36

(52) U.S. Cl. CPC G09G 3/3406; G02F 1/1336; G09G 2320/08; G09G 2320/0626; G09G 3/36

(57) ABSTRACT

The present invention provides a backlight brightness automatic adjusting system adapting various liquid crystal panels and a liquid crystal display. The backlight brightness automatic adjusting system employs the sequence controller (20) to perform data exchange with the liquid crystal panel (10), and the sequence controller (20) detects a structure or resolution information of the liquid crystal panel (10), and transmits the structure of the liquid crystal panel or the resolution information (10) to the micro controller (30) in an instruction form, and the micro controller (30) correspondingly outputs pulse signals of various duty ratios according to various instructions obtained from the sequence controller (20) to control a switch degree of the MOS transistor (Q), and thus to automatically adjust a current flowing through the LED light bar (40) and a brightness of the LED light bar (40).

### FIELD OF THE INVENTION

The present invention relates to a display technology field, and more particularly to a backlight brightness automatic adjusting system adapting various liquid crystal panels and a liquid crystal display.

### BACKGROUND OF THE INVENTION

The LCD (Liquid Crystal Display) possesses many advantages of being ultra thin, power saved and radiation free. It has been widely utilized in, such as LCD TVs, mobile phones, personal digital assistants (PDA), digital cameras, laptop screens or notebook screens.

Most of the liquid crystal displays on the present market are backlight type liquid crystal displays, which comprise a liquid crystal display panel and a backlight module. The working principle of the liquid crystal panel is that the driving voltages are applied to the Thin Film Transistor Array Substrate (TFT array substrate) and the Color Filter (CF) so that the light of backlight module is refracted to generate images for controlling the rotations of the liquid crystal molecules between the two substrates.

Because the liquid crystal display panel itself does not emit light and needs the back light module to provide light source for normally showing images. Therefore, the backlight module is the key component of the liquid crystal display. According to the different light source incident positions, the backlight module can be categorized into two kinds, the side light type backlight module and a direct light type backlight module. The direct light type backlight module is to locate the light emitting source, such as the Cold Cathode Fluorescent Lamp (CCFL) or Light Emitting Diode (LED) behind the liquid crystal panel to directly form an area light source to be provided to the liquid crystal panel. The side light type backlight module is to locate the LED light bars at the lateral back side of the liquid crystal panel to be the backlight source.

FIG. 1 shows a circuit diagram of a backlight system according to prior art, which comprises a Microprogrammed Control Unit (MCU) 10′ of a Converter, a plurality of LED light bars 20′ electrically coupled to the MCU 10′, and a MSO transistor Q′ and a resistor R′ coupled in series on each LED light bar 20′, and each LED light bar 20′ comprises a plurality of light emitting diodes D′ coupled in series. One end of the LED light bar 20′ is coupled to a positive voltage level pin of the micro controller 10′, and the other end is coupled to a negative voltage level pin of the micro controller 10′ through the MOS transistor Q′ and the resistor R′ coupled in series therewith; a gate of the MOS transistor Q′ is coupled to a brightness control pin C′ of the micro controller 10′, and a source and a drain are electrically coupled to the LED light bar 20′ and one end of the resistor R′, respectively; the other end of the resistor R′ is coupled to the negative voltage level pin of the micro controller 10′.

The micro controller 10′ outputs the pulse signal to the gate of the MOS transistor Q′ through the brightness control pin C′ and utilizes the voltage duty ratio of the pulse signal to control the switch degree of the MOS transistor Q′, and thus to adjust a current flowing through the LED light bar 20′ and a corresponding brightness of the LED light bar 20′. Because the micro controller 10′ only has one code, and one code only corresponds to one kind of pulse signal, which only can correspond to single current flowing through the LED light bar 20′, and the brightness of the LED light bar 20′ is fixed.

At present, the resolutions, the transmission rates of the liquid crystal panels of different types are different. Therefore, the backlight brightnesses required for the various liquid crystal panels are different. When the backlight system deals with the liquid crystal panels of various resolutions, various transmission rates, the converter needs to be replaced or the micro controller has to be written with new codes for obtaining the suitable optical brightness in accordance with the various liquid crystal panels. It inevitably increases the cost and the quality control of the liquid crystal display becomes more complicated.

### SUMMARY OF THE INVENTION

An objective of the present invention is to provide a backlight brightness automatic adjusting system adapting various liquid crystal panels which can realize adjusting the backlight brightness according to the various liquid crystal panels in accordance with the backlight to save the working hours and man power for replacing the converter or replacing the program codes of the micro controller to realize automation.

Another objective of the present invention is to provide a liquid crystal display comprising a backlight brightness automatic adjusting system adapting various liquid crystal panels which can realize adjusting the backlight brightness according to the various liquid crystal panels in accordance with the backlight to save the working hours and man power for replacing the converter or replacing the program codes of the micro controller to realize automation.

For realizing the aforesaid objective, the present invention first provides a backlight brightness automatic adjusting system adapting various liquid crystal panels, comprising a liquid crystal panel, a sequence controller electrically coupled to the liquid crystal panel, a micro controller electrically coupled to the sequence controller, a plurality of LED light bars electrically coupled to the micro controller and a MOS transistor and a resistor coupled in series with each LED light bar;

the sequence controller performs data exchange with the liquid crystal panel, and the sequence controller detects a structure or resolution information of the liquid crystal panel, and transmits the structure or the resolution information of the liquid crystal panel to the micro controller in an instruction form, and the micro controller correspondingly outputs pulse signals of various duty ratios according to various instructions obtained from the sequence controller to control a switch degree of the MOS transistor, and thus to automatically adjust a current flowing through the LED light bar and a brightness of the LED light bar.

The micro controller stores a preset data table inside, and the preset data table defines a corresponding relationship of various instructions transmitted by the sequence controller and various program codes in the micro controller, and one kind of program code corresponds to one kind of pulse signal of duty ratio.

The sequence controller detects the structure or the resolution information of the liquid crystal panel according to a scan time of the liquid crystal panel or a data digital number transmitted to the liquid crystal panel.

Each LED light bar comprises a plurality of light emitting diodes coupled in series, and one end of the LED light bar is coupled to a positive voltage level pin of the micro controller, and the other end is coupled to a negative voltage level pin of the micro controller through the MOS transistor and the resistor coupled in series therewith; a gate of the MOS transistor is coupled to a brightness control pin of the micro controller, and a source and a drain are electrically coupled to the LED light bar and one end of the resistor, respectively; the other end of the resistor is coupled to the negative voltage level pin of the micro controller; the pulse signal is transmitted to the gate of the MOS transistor through the brightness control pin.

The present invention further provides a liquid crystal display, comprising a backlight brightness automatic adjusting system adapting various liquid crystal panels; the backlight brightness automatic adjusting system adapting various liquid crystal panels comprises a liquid crystal panel, a sequence controller electrically coupled to the liquid crystal panel, a micro controller electrically coupled to the sequence controller, a plurality of LED light bars electrically coupled to the micro controller and a MOS transistor and a resistor coupled in series with each LED light bar;

the sequence controller performs data exchange with the liquid crystal panel, and the sequence controller detects a structure or resolution information of the liquid crystal panel, and transmits the structure or the resolution information of the liquid crystal panel to the micro controller in an instruction form, and the micro controller correspondingly outputs pulse signals of various duty ratios according to various instructions obtained from the sequence controller to control a switch degree of the MOS transistor, and thus to automatically adjust a current flowing through the LED light bar and a brightness of the LED light bar.

The micro controller stores a preset data table inside, and the preset data table defines a corresponding relationship of various instructions transmitted by the sequence controller and various program codes in the micro controller, and one kind of program code corresponds to one kind of pulse signal of duty ratio.

The sequence controller detects the structure or the resolution information of the liquid crystal panel according to a scan time of the liquid crystal panel or a data digital number transmitted to the liquid crystal panel.

Each LED light bar comprises a plurality of light emitting diodes coupled in series, and one end of the LED light bar is coupled to a positive voltage level pin of the micro controller, and the other end is coupled to a negative voltage level pin of the micro controller through the MOS transistor and the resistor coupled in series therewith; a gate of the MOS transistor is coupled to a brightness control pin of the micro controller, and a source and a drain are electrically coupled to the LED light bar and one end of the resistor, respectively; the other end of the resistor is coupled to the negative voltage level pin of the micro controller; the pulse signal is transmitted to the gate of the MOS transistor through the brightness control pin.

The present invention further provides a liquid crystal display, comprising a backlight brightness automatic adjusting system adapting various liquid crystal panels; the backlight brightness automatic adjusting system adapting various liquid crystal panels comprises a liquid crystal panel, a sequence controller electrically coupled to the liquid crystal panel, a micro controller electrically coupled to the sequence controller, a plurality of LED light bars electrically coupled to the micro controller and a MOS transistor and a resistor coupled in series with each LED light bar;

the sequence controller performs data exchange with the liquid crystal panel, and the sequence controller detects a structure or resolution information of the liquid crystal panel, and transmits the structure or the resolution information of the liquid crystal panel to the micro controller in an instruction form, and the micro controller correspondingly outputs pulse signals of various duty ratios according to various instructions obtained from the sequence controller to control a switch degree of the MOS transistor, and thus to automatically adjust a current flowing through the LED light bar and a brightness of the LED light bar;

wherein the micro controller stores a preset data table inside, and the preset data table defines a corresponding relationship of various instructions transmitted by the sequence controller and various program codes in the micro controller, and one kind of program code corresponds to one kind of pulse signal of duty ratio.

The benefits of the present invention are: the present invention provides a backlight brightness automatic adjusting system adapting various liquid crystal panels and a liquid crystal display. The sequence controller performs data exchange with the liquid crystal panel, and the sequence controller detects a structure or resolution information of the liquid crystal panel, and transmits the structure or the resolution information of the liquid crystal panel to the micro controller in an instruction form, and the micro controller correspondingly outputs pulse signals of various duty ratios according to various instructions obtained from the sequence controller to control a switch degree of the MOS transistor, and thus to automatically adjust a current flowing through the LED light bar and a brightness of the LED light bar. It realizes adjusting the backlight brightness according to the various liquid crystal panels in accordance with the backlight to save the working hours and man power for replacing the converter or replacing the program codes of the micro controller to realize automation.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a circuit diagram of a backlight system according to prior art;

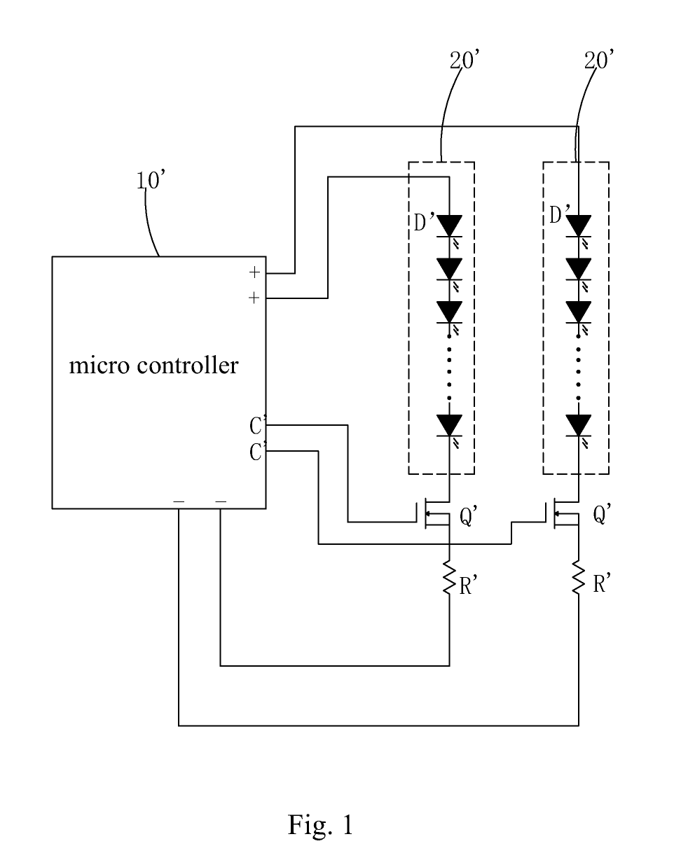

FIG. 2 is a circuit diagram of a backlight brightness automatic adjusting system adapting various liquid crystal panels according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

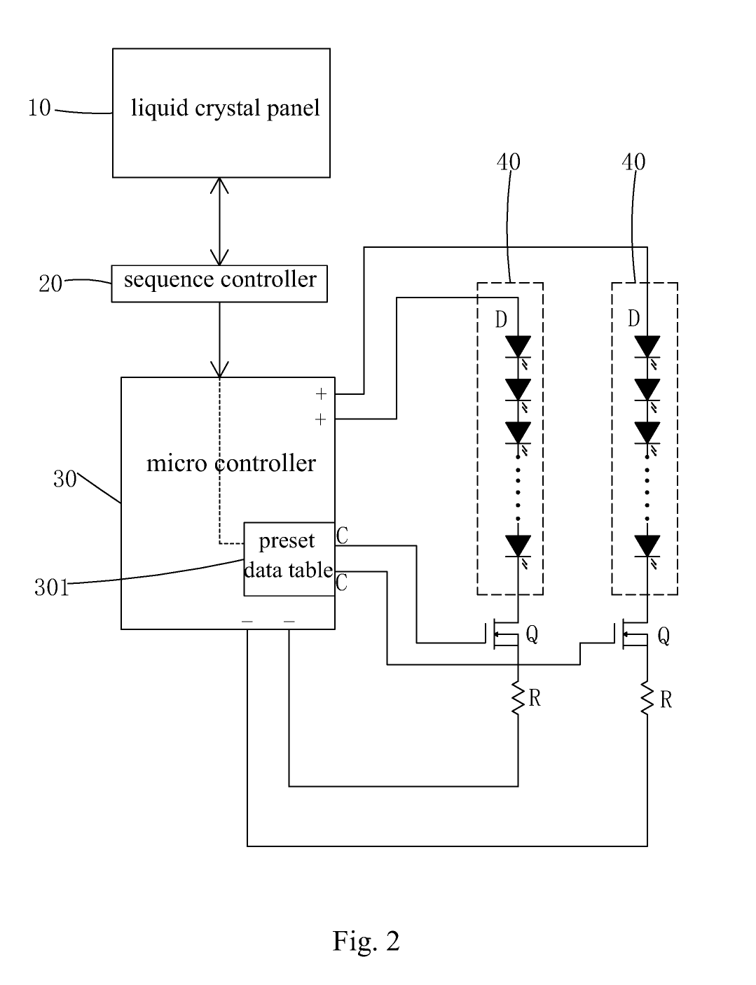

Please refer to FIG. 2. The present invention first provides a backlight brightness automatic adjusting system adapting various liquid crystal panels, comprising a liquid crystal panel 10, a sequence controller 20 electrically coupled to the liquid crystal panel 10, a micro controller 30 electrically coupled to the sequence controller 20, a plurality of LED light bars 40 electrically coupled to the micro controller 30 and a MOS transistor Q and a resistor R coupled in series with each LED light bar 40.

The display panel 10 requires specific backlight brightness according to the structure or the resolution of itself. The sequence controller 20 performs data exchange with the liquid crystal panel 10, and the sequence controller 20 detects a structure or resolution information of the liquid crystal panel 10 to generate the various instructions corresponding to the structure or the resolution information of the liquid crystal panel 10 one by one, and transmits the structure or the resolution information of the liquid crystal panel 10 to the micro controller 30 in an instruction form. The micro controller 30 correspondingly outputs pulse signals of various duty ratios according to various instructions obtained from the sequence controller 20 to control a switch degree of the MOS transistor Q, and thus to automatically adjust a current flowing through the LED light bar 40 and a brightness of the LED light bar 40.

Specifically, the sequence controller 20 detects the structure or resolution information of the liquid crystal panel 10 according to a scan time of the liquid crystal panel 10 or a data digital number transmitted to the liquid crystal panel 10.

The micro controller 30 stores a preset data table 301 inside, and the preset data table 301 defines a corresponding relationship of various instructions transmitted by the sequence controller 20 and various program codes in the micro controller 30, and the micro controller 30 confirms the program code corresponding to some instruction with the preset data table 301, and one kind of program code corresponds to one kind of pulse signal of duty ratio. Under circumstance that the backlight is in accordance with one liquid crystal panel, the sequence controller 20 detects the structure or the resolution of the one liquid crystal panel, and generates the instructions corresponding to the structure or the resolution of the one liquid crystal panel. For instance, the resolution of the liquid crystal panel is 1920×1080, and the corresponding instruction is 01, the micro controller 30 looks up in the preset data table 301 after receiving the corresponding instruction 01 transmitted by the sequence controller 20 to obtain the program codes corresponded with the corresponding instruction 01, and correspondingly outputs a pulse signal with a kind of specific duty ratio according to the program code. The pulse signal controls the switch degree of the MOS transistor Q, and thus to automatically adjust a current flowing through the LED light bar 40 and a brightness of the LED light bar 40 so that the brightness of the LED light bar 40 satisfies the requirement of the one liquid crystal panel; under circumstance that the backlight is in accordance with another liquid crystal panel, the sequence controller 20 detects the structure or the resolution of the another liquid crystal panel, and generates the instructions corresponding to the structure or the resolution of the one liquid crystal panel. For instance, the resolution of the liquid crystal panel is 3820×2160, and the corresponding instruction is 11, the micro controller 30 looks up in the preset data table 301 after receiving the corresponding instruction 01 transmitted by the sequence controller 20 to obtain the program codes corresponded with the corresponding instruction 11, and correspondingly outputs a pulse signal with a kind of specific duty ratio according to the program code. The pulse signal controls the switch degree of the MOS transistor Q, and thus to automatically adjust a current flowing through the LED light bar 40 and a brightness of the LED light bar 40 so that the brightness of the LED light bar 40 satisfies the requirement of the another liquid crystal panel.

Furthermore, each LED light bar 40 comprises a plurality of light emitting diodes D coupled in series, and one end of the LED light bar 40 is coupled to a positive voltage level pin of the micro controller 30, and the other end is coupled to a negative voltage level pin of the micro controller 30 through the MOS transistor Q and the resistor R coupled in series therewith; a gate of the MOS transistor Q is coupled to a brightness control pin C of the micro controller 30, and a source and a drain are electrically coupled to the LED light bar 40 and one end of the resistor R, respectively; the other end of the resistor R is coupled to the negative voltage level pin − of the micro controller 30; the pulse signal is transmitted to the gate of the MOS transistor Q through the brightness control pin C. The pulse signals of various duty ratios control the conduction and the on-off time of the MOS transistors Q to be different. Namely, the switch degrees of the MOS transistors Q are different.

The backlight brightness automatic adjusting system adapting various liquid crystal panels of the present invention does not have to replace the converter or to replace the form of the program codes of the micro controller to adapt the requirements of the backlight brightnesses of the various liquid crystal panels like prior art does. The sequence controller 20 detects the structure or the resolution of the liquid crystal panel 10, and transmits the structure or the resolution information of the liquid crystal panel 10 to the micro controller 30 in an instruction form, and the micro controller 30 correspondingly outputs pulse signals of various duty ratios according to various instructions obtained from the sequence controller 20 to control a switch degree of the MOS transistor Q, and thus to automatically adjust a current flowing through the LED light bar 40 and a brightness of the LED light bar 40. It realizes adjusting the backlight brightness according to the various liquid crystal panels in accordance with the backlight to save the working hours and man power for replacing the converter or replacing the program codes of the micro controller to realize automation.

On the basis of the same inventive idea, the present invention further provides a backlight brightness automatic adjusting system adapting various liquid crystal panels as shown in the aforesaid FIG. 2, which can realize adjusting the backlight brightness according to the various liquid crystal panels in accordance with the backlight to save the working hours and man power for replacing the converter or replacing the program codes of the micro controller to realize automation. The description of the backlight brightness automatic adjusting system adapting various liquid crystal panels is not repeated here.

In conclusion, the present invention provides a backlight brightness automatic adjusting system adapting various liquid crystal panels and a liquid crystal display. The sequence controller performs data exchange with the liquid crystal panel, and the sequence controller detects a structure or resolution information of the liquid crystal panel, and transmits the structure or the resolution information of the liquid crystal panel to the micro controller in an instruction form, and the micro controller correspondingly outputs pulse signals of various duty ratios according to various instructions obtained from the sequence controller to control a switch degree of the MOS transistor, and thus to automatically adjust a current flowing through the LED light bar and a brightness of the LED light bar. It realizes adjusting the backlight brightness according to the various liquid crystal panels in accordance with the backlight to save the working hours and man power for replacing the converter or replacing the program codes of the micro controller to realize automation.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A backlight brightness automatic adjusting system adapting various liquid crystal panels, comprising a liquid crystal panel, a sequence controller electrically coupled to the liquid crystal panel, a micro controller electrically coupled to the sequence controller, a plurality of LED light bars electrically coupled to the micro controller and a MOS transistor and a resistor coupled in series with each LED light bar;
the sequence controller performs data exchange with the liquid crystal panel, and the sequence controller detects a structure or resolution information of the liquid crystal panel, and transmits the structure or the resolution information of the liquid crystal panel to the micro controller in an instruction form, and the micro controller correspondingly outputs pulse signals of various duty ratios according to various instructions obtained from the sequence controller to control a switch degree of the MOS transistor, and thus to automatically adjust a current flowing through the LED light bar and a brightness of the LED light bar.

2. The backlight brightness automatic adjusting system adapting various liquid crystal panels according to claim 1, wherein the micro controller stores a preset data table inside, and the preset data table defines a corresponding relationship of various instructions transmitted by the sequence controller and various program codes in the micro controller, and one kind of program code corresponds to one kind of pulse signal of duty ratio.

3. The backlight brightness automatic adjusting system adapting various liquid crystal panels according to claim 2, wherein the sequence controller detects the structure or the resolution information of the liquid crystal panel according to a scan time of the liquid crystal panel or a data digital number transmitted to the liquid crystal panel.

4. The backlight brightness automatic adjusting system adapting various liquid crystal panels according to claim 2, wherein each LED light bar comprises a plurality of light emitting diodes coupled in series, and one end of the LED light bar is coupled to a positive voltage level pin of the micro controller, and the other end is coupled to a negative voltage level pin of the micro controller through the MOS transistor and the resistor coupled in series therewith; a gate of the MOS transistor is coupled to a brightness control pin of the micro controller, and a source and a drain are electrically coupled to the LED light bar and one end of the resistor, respectively; the other end of the resistor is coupled to the negative voltage level pin of the micro controller; the pulse signal is transmitted to the gate of the MOS transistor through the brightness control pin.

5. A liquid crystal display, comprising a backlight brightness automatic adjusting system adapting various liquid crystal panels; the backlight brightness automatic adjusting system adapting various liquid crystal panels comprises a liquid crystal panel, a sequence controller electrically coupled to the liquid crystal panel, a micro controller electrically coupled to the sequence controller, a plurality of LED light bars electrically coupled to the micro controller and a MOS transistor and a resistor coupled in series with each LED light bar;
the sequence controller performs data exchange with the liquid crystal panel, and the sequence controller detects a structure or resolution information of the liquid crystal panel, and transmits the structure or the resolution information of the liquid crystal panel to the micro controller in an instruction form, and the micro controller correspondingly outputs pulse signals of various duty ratios according to various instructions obtained from the sequence controller to control a switch degree of the MOS transistor, and thus to automatically adjust a current flowing through the LED light bar and a brightness of the LED light bar.

6. The liquid crystal display according to claim 5, wherein the micro controller stores a preset data table inside, and the preset data table defines a corresponding relationship of various instructions transmitted by the sequence controller and various program codes in the micro controller, and one kind of program code corresponds to one kind of pulse signal of duty ratio.

7. The liquid crystal display according to claim 6, wherein the sequence controller detects the structure or the resolution information of the liquid crystal panel according to a scan time of the liquid crystal panel or a data digital number transmitted to the liquid crystal panel.

8. The liquid crystal display according to claim 6, wherein each LED light bar comprises a plurality of light emitting diodes coupled in series, and one end of the LED light bar is coupled to a positive voltage level pin of the micro controller, and the other end is coupled to a negative voltage level pin of the micro controller through the MOS transistor and the resistor coupled in series therewith; a gate of the MOS transistor is coupled to a brightness control pin of the micro controller, and a source and a drain are electrically coupled to the LED light bar and one end of the resistor, respectively; the other end of the resistor is coupled to the negative voltage level pin of the micro controller; the pulse signal is transmitted to the gate of the MOS transistor through the brightness control pin.

9. A liquid crystal display, comprising a backlight brightness automatic adjusting system adapting various liquid crystal panels; the backlight brightness automatic adjusting system adapting various liquid crystal panels comprises a liquid crystal panel, a sequence controller electrically coupled to the liquid crystal panel, a micro controller electrically coupled to the sequence controller, a plurality of LED light bars electrically coupled to the micro controller and a MOS transistor and a resistor coupled in series with each LED light bar;
the sequence controller performs data exchange with the liquid crystal panel, and the sequence controller detects a structure or resolution information of the liquid crystal panel, and transmits the structure or the resolution information of the liquid crystal panel to the micro controller in an instruction form, and the micro controller correspondingly outputs pulse signals of various duty ratios according to various instructions obtained from the sequence controller to control a switch degree of the MOS transistor, and thus to automatically adjust a current flowing through the LED light bar and a brightness of the LED light bar;
wherein the micro controller stores a preset data table inside, and the preset data table defines a corresponding relationship of various instructions transmitted by the sequence controller and various program codes in the micro controller, and one kind of program code corresponds to one kind of pulse signal of duty ratio.

10. The liquid crystal display according to claim 9, wherein the sequence controller detects the structure or the resolution information of the liquid crystal panel according to a scan time of the liquid crystal panel or a data digital number transmitted to the liquid crystal panel.

11. The liquid crystal display according to claim 9, wherein each LED light bar comprises a plurality of light emitting diodes coupled in series, and one end of the LED light bar is coupled to a positive voltage level pin of the micro controller, and the other end is coupled to a negative voltage level pin of the micro controller through the MOS transistor and the resistor coupled in series therewith; a gate of the MOS transistor is coupled to a brightness control pin of the micro controller, and a source and a drain are electrically coupled to the LED light bar and one end of the resistor, respectively; the other end of the resistor is coupled to the negative voltage level pin of the micro controller; the pulse signal is transmitted to the gate of the MOS transistor through the brightness control pin.
